(19) United States
(12) Patent Application Publication
(10) Pub. No.: US 2016/0006466 A1
(43) Pub. Date: Jan. 7, 2016

(54) PROGRAMMABLE HETERODINE ACTIVE FILTER FOR TELECOMMUNICATIONS RECEIVERS

(71) Applicant: TETRACEL S.A., Ciudad de Cordoba (AR)

(72) Inventor: Ricardo Matias De Goycoechea, Ciudad de Cordoba (AR)

(21) Appl. No.: 14/791,573

(22) Filed: Jul. 6, 2015

Related U.S. Application Data
(60) Provisional application No. 62/021,315, filed on Jul. 7, 2014.

(51) Int. Cl. H04B 1/10

(52) U.S. Cl. CPC H04B 1/1027

(57) ABSTRACT

The present invention relates to a programmable filtering system that allows the telecommunications receivers to maintain and improve their reception quality against high levels of noise floor and/or the presence of unwanted signals. The filtering system is portable and of a compact size, similar to the telecommunications receiver.

### CROSS-REFERENCE TO RELATED APPLICATIONS

This application claims the benefit of priority to U.S. Provisional Application No. 52/021,315 filed Jul. 7, 2014, the contents of which are incorporated herein by reference.

### FIELD OF THE INVENTION

The present disclosure relates to a filter for telecommunications receivers. More specifically, the present disclosure relates to a programmable heterodyne active filter for telecommunications receivers.

### BACKGROUND OF THE INVENTION

In recent years, telecommunications receivers, such as for example, base stations, repeaters stations, mobile and portable equipment, are becoming more sensitive and of a major bandwidth in order to be able to receive weaker signals and to be more versatile regarding its operation band. In addition, the radio electric spectrum is becoming more congested with the large presence of radio frequency signals with different modulation formats, and the floor noise is also becoming increasingly high. All of these produce degradation of the reception quality, thus diminishing the scope of the telecommunications systems and decreasing the ability to handle calls and data traffic. This degradation is because the present radio electric noise is increasingly higher and the receiving channels are within strong adjacent, semi-adjacent, or nearby signals, which reach the receiver. The sum of all of the above produces a devoicing of the receiver, which may be partial or total, preventing in this way a correct demodulation and operation.

To ensure that the telecommunications system receivers are not interfered or disturbed by the floor noise and/or by the presence of radio frequency signals of the adjacent channels, semi adjacent, or nearby, independent of the modulation formats and the operating frequency bands, the prior art uses radio frequency filters such as, for example, pass band, band reject - pass band, or band reject, in association with other electronic components such as capacitors, inductors, and resistances or components in the form of line sections of specific line transmission. These components use distributed parameters (resonant cavities of any mode or wave guides), which provide some type of filtering to the radio electric spectrum that passes through them, partially eliminating the unwanted signals and decreasing the floor level noise.

Unfortunately, there are problems associated with the known radio frequency filters. Due to the nature of the filters, the desired quality factors are not high, thus, the filtering responses are not steep or very selective, and the filtering task is not efficient, In addition, due to the nature of the filters, insertion losses are generated that affects the signals that are intended to be received, thus generating a loss in the quality of the reception of the signals of interest. Furthermore, the known radio frequency filters cannot be tunable in the field, thus, any change in the receiver frequency creates the need to perform a new calibration of the filter and this task should be performed in a laboratory. In addition, known radio frequency filters are of large size and volume, which occupy a large space and the cost is high.

In addition, the prior art also discloses filtering by using quartz crystal filters or surface acoustic wave filters (surface acoustic wave or SAW), which provide high selectivity with high loss levels by the inclusion. The insertion loss can be compensated by amplification stage. Unfortunately, the quartz crystal filters present some problems. Due to the nature of the quartz crystal filters, the filters are produced for a specific frequency and cannot be re-tunable, either in the field or the laboratory. Facing a change of frequency, it is necessary to manufacture a new unit. In addition, depending on the substrate used, the SAW filters-based present deviations from their tuning depending on the ambient temperature, generating operating problems. Furthermore, due to the nature of quartz crystal filters or SAW type, high losses are generated by the inclusion that affects signals that are intended to be received, thus generating a loss in the quality of the reception of the signals of interest. Finally, the quartz crystal filters are expensive.

Furthermore, the prior art also discloses filtering using the digital processing of signals, which carry the radio electric spectrum of the analog field to the digital field, introducing the digitized spectrum through an analog-to-digital converter to any DSP or FPGA type platform, where through mathematical operations the filtering is performed, converting the treated digital signals once again to the analog field using a digital-to-analog converter. Unfortunately, the digital processing of signals also presents problems. The digital processing of signals is expensive. In addition, due to the nature of the analog-to-digital conversions, it is necessary to have good levels of the input signals in order to prevent quantization errors, but high floor noise and/or unwanted signals that have greater amplitude than the desired signals can saturate the digitalization system, decreasing the quality of the filtered signals of interest. Furthermore, because they are sampling methods, there is a risk of losing the information in the transfer from analog to digital and then digital to analog, losing quality of the filtered signals of interest. Finally, because they are sampling methods, it is sensitive to the modulation format that the receiving system is used.

Thus, there is a need for a filter system that overcomes all of the problems presented by the known telecommunication filters.

### SUMMARY OF THE INVENTION

The present disclosures provides a filtering system that allows the telecommunications receivers to maintain and improve their reception quality against high levels of floor noise and/or the presence of unwanted signals; that is inexpensive to produce; that is portable and with a compact size similar to the telecommunications receiver; that includes a type pass band topology and with a very high quality factor that allows to provide very aggressive filtering to adjacent channels, semi-adjacent, or near; that includes gain stages of low level of added noise with the objective of preventing insertion loss; that is immune to adjacent, semi adjacent, or nearby signals independent of their level, and that these signals do not affect the operation of the active filter, preventing the degrading of the quality of the filtered signals of interest; that is immune to the existing noise floor level, and that this noise floor level does not affect the operation of the active filter, preventing the degrading of the quality of the filtered signals of interest; that is suitable for any type of technology independent of its modulation technology and does not generate quantization errors; that can be adjusted in the field without the need for using laboratory instrumentation, and that can be adapted to changes in the frequency of the desired reception signals; and that is adjustable, allowing to provide a multi-channel solution that runs simultaneously on all required portions of the spectrum, depending on the geographical context where the solution is applied.

The present invention includes a programmable heterodyne active filter system for a telecommunication receiver having a printed circuit board inside a casing; a capturing device operatively connected to the printed circuit board that is inside the casing via an input connector, the capturing device captures and/or radiates electromagnetic wave signals present in a radio electric spectrum of interest of a telecommunication device; the mentioned printed circuit board housed inside the casing; the printed circuit board including: a first pre-selection filter connected to the capturing device, the first pre-selection filter receives the captured signal from the capturing device and filters the capturing signal to an operational band; an adjustable radio frequency amplifier connected to the first pre-selection filter, the adjustable radio frequency amplifier amplifies the filtered radio electric spectrum of interest, the radio frequency amplifier is of low level of added noise and includes an adjustable gain chain setting; a first frequency translator device connected to the adjustable radio frequency amplifier, the first frequency translator device takes the amplified radio electric spectrum of interest exiting the radio frequency amplifier and creates a heterodyne reduction of the radio electric spectrum of interest to an intermediate frequency band; an intermediate frequency filtering device connected to the first frequency translator device, the intermediate frequency filtering device filters the intermediate frequency signal according to a selectable bandwidth that only allows to pass a portion of the spectrum that contains the information of the signal of interest that it intended to be filtered; a second frequency translation device connected to the intermediate frequency filtering device, the second frequency translation device transfers the filtered intermediate frequency signal to the original frequency band signal; a second filter selector connected to the second frequency translation device, the second filter selector takes the original frequency band signal and eliminates false signals, harmonics, and images; an amplifier connected to the second filter, the amplifier takes the filtered signal from the second filter selector and amplifies the signal and then sends the amplified signal through an output connector operatively connected to the printed circuit board; and an internal control unit independently connected to the pre-selection filter, the frequency synthesizer, and an external energy source.

In addition, the present inventions relates to a method for filtering a radio electric spectrum signal for a telecommunication receiver, the method having the steps of: transporting to a location the programmable heterodyne active filter system for a telecommunication receiver of claim 1; capturing the radio electric spectrum where the signal of interest of the telecommunications receiver is located; pre-filtering the received radio electric spectrum of interest to make an initial selection of the band of operation; amplifying the spectrum signal with low added noise and variable gain stages; reducing by heterodyne the radio electric spectrum to an intermediate frequency band; filtering the signal of interest through filtering elements in the intermediate frequency whose bandwidth only lets to pass the bandwidth that contains a selected information of the signal of interest and refuses spectral components that are out of the bandwidth; carrying the filtered frequency of interest from the interest intermediate band to the original radio electric spectrum band; and sending the signal to the telecommunications receiver.

### BRIEF DESCRIPTION OF THE DRAWINGS

FIG. 1 shows a diagram showing the programmable heterodyne active filter system for telecommunication receiver according to an embodiment of the present invention;

FIG. 2 shows a top view of the programmable heterodyne active filter system of FIG. 1 showing the system inside a casing in a closed position;

FIG. 3 shows a bottom view of the programmable heterodyne active filter system of FIG. 2;

FIG. 4 shows an exploded view of the programmable heterodyne active filter system for telecommunication receiver showing the clamps removed from the casing of Sprinted circuit;

FIG. 5 shows a bottom view of the programmable heterodyne active filter system for telecommunication receiver showing a casing, the clamps removed from the casing, a printed circuit removed from the casing; and

FIG. 6 shows a top view of the programmable heterodyne active filter system for telecommunication receiver showing a casing, the clamps removed from the casing, a printed circuit removed from the casing.

### DETAILED DESCRIPTION OF THE INVENTION

The programmable heterodyne active filter for telecommunications receivers according to an embodiment of the present invention bases its operation principle in the heterodyne treatment of the intermediate frequency of the spectrum of interest. In addition, the present invention provides the method thereof.

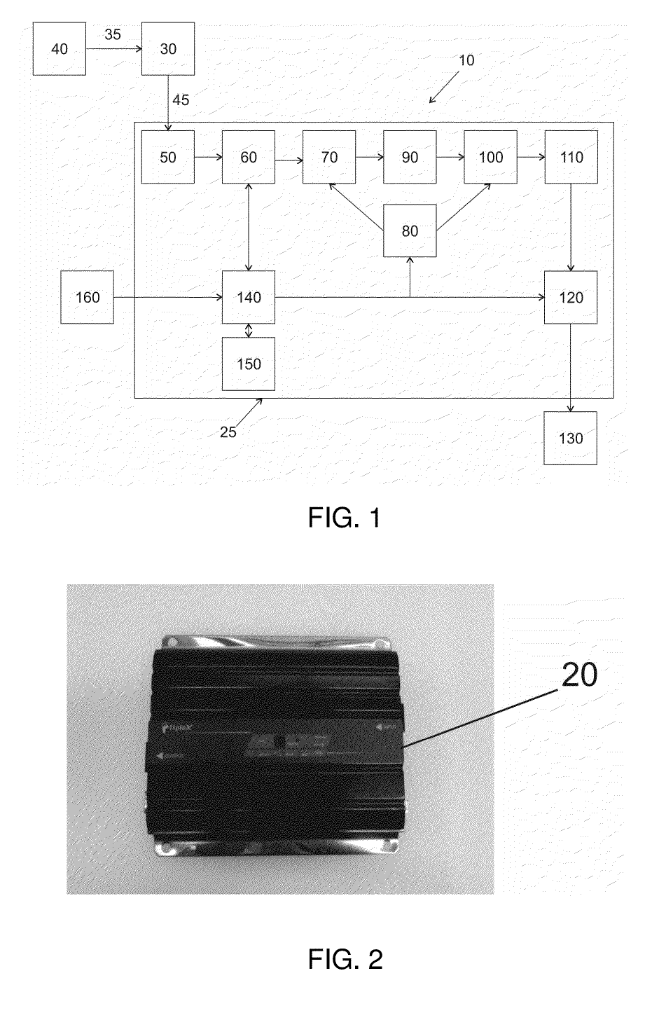

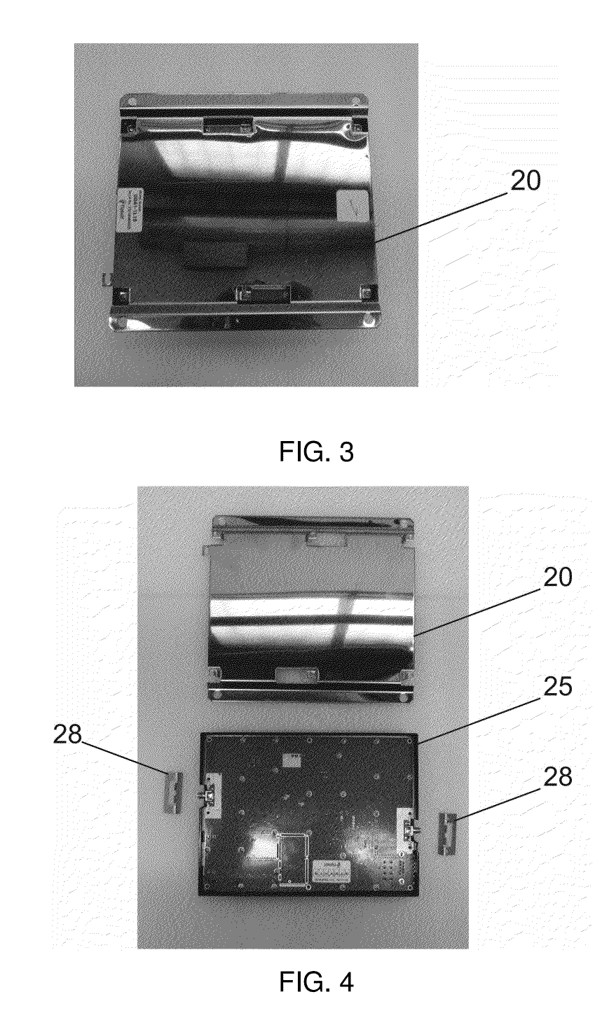

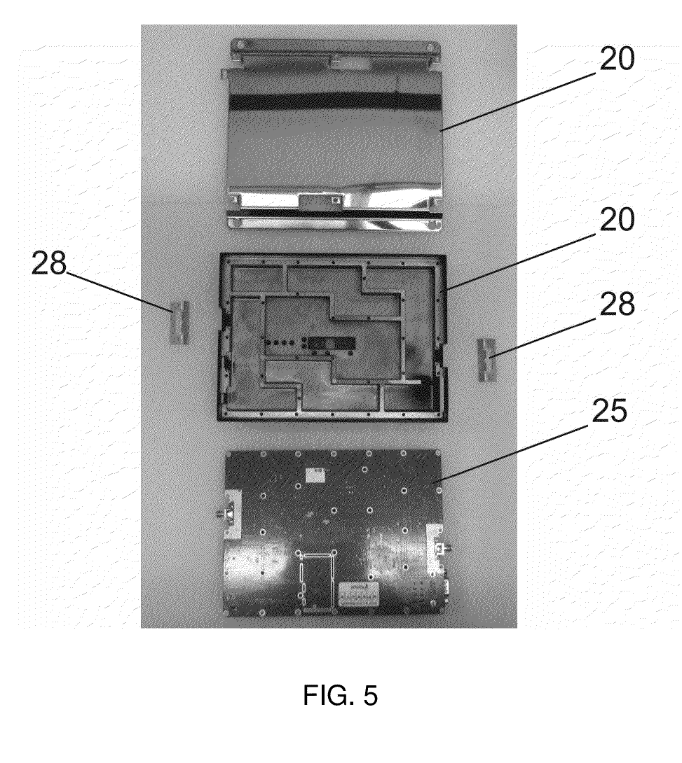

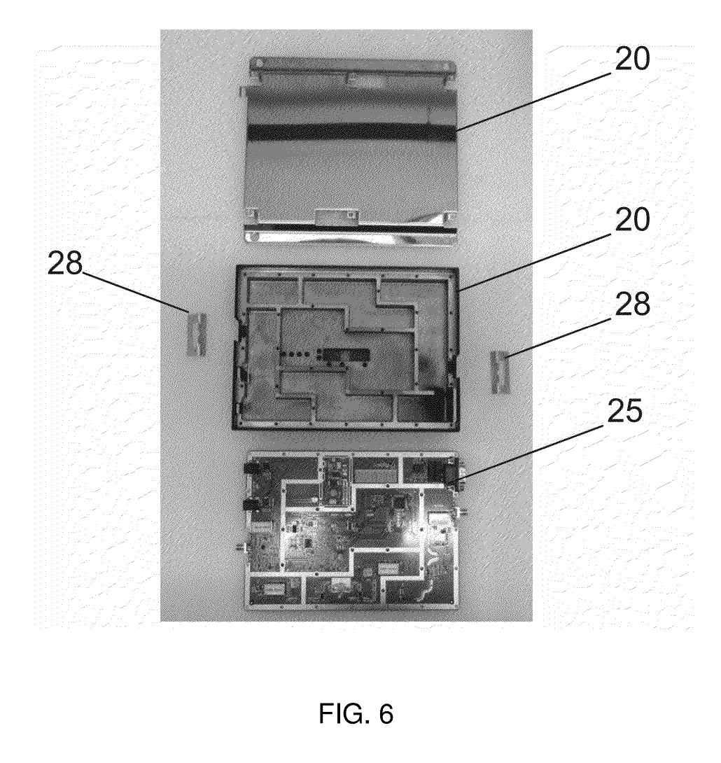

FIG. 1 shows the diagram showing the programmable heterodyne active filter system 10 for telecommunication receiver according to an embodiment of the present invention. The system 10 is a portable system and may include all of the elements of the system connected into a printed circuit board (PCB) 25 placed inside a casing 20 (FIGS. 2-6). The casing 20 acts as a mechanical support and as a radio electric shielding. The casing 20 may be made of a sturdy material, for example, metal or metallized plastic. In some embodiments, the casing 20 may be made of a metal material.

A clamp 28 may serve as a mechanical fixing element for installation on the printed circuit board 25 into the casing 20. The clamp 28 may be any commercially available clamp or fastener that allows to mechanically connect the printed circuit board 25 onto the casing 20.

A capturing device 30 is operatively connected to the printed circuit board 25 that is inside the casing 20. The capturing device 30 may capture and/or radiate the radiated electromagnetic waves of the signals 35 present in the radio electric spectrum of a telecommunication system 40. This capture of the radio electric spectrum is done where signal reception of interest is located.

The capturing device 30 may be, for example, an antenna, a satellite dish, or any radio frequency physical device that links, wired or wireless, to the original signal source.

The signal 35 may be generated by a generator device (not shown) of the telecommunication system 40, whether within or outside the area where the operation of the communication devices is intended to be hindered, whether it is terrestrial, maritimal, aerial, or spatial.

The capturing device 30 may send the captured signal 45 towards the entrance of the filter system 10 by using any radio frequency conductive medium.

A first pre-selection filter 50 inside the casing 20 of the filtering system 10 may receive the captured signal 45. The captured signal 45 is pre-filtered through the pre-selection filter 50 that defines the operation band of the active filter. The first pre-selection filter 50 may be made by lumped elements, surface acoustic wave, distributed elements, or any other kind of radio-electric filter.

An adjustable radio frequency amplifier 60 amplified the radio electric spectrum of interest after which exists the pre-selection filter 50. The radio frequency amplifier 60 is of low level of added noise and includes an adjustable gain setting. The adjustable radio frequency amplifier 60 may be, for example, a radio frequency low noise amplifier with a pin diode adjustable attenuator that enhances the CS level with a specific desired level.

A first frequency translator device 70 takes the amplified radio electric spectrum of interest exiting the radio frequency amplifier 60 and produces an heterodyne reduction of the radio electric spectrum of interest to an intermediate frequency band. The first frequency translator device 70 may be, but not limited to, an analog circuit composed by an input radio frequency matching and filtering circuit that adapts impedances and/or eliminates unwanted CS radio frequency spectrum, an input radio frequency mixer that heterodinizes the radio frequency CS into intermediate frequency CS spectrum, with the input radio frequency mixer being driven by a programmable continuous wave non-modulated signal source like a frequency synthesizer.

The intermediate frequency selection is carried out by the programming of a frequency synthesizer 80, which generates the specific local oscillator and feeds the frequency translator device 70 as it known by a standard heterodinization process.

An intermediate frequency filtering device 90 takes the intermediate frequency exiting the frequency synthesizer 80. The intermediate frequency filtering device 90 filters the intermediate frequency signal according to a selectable bandwidth that only allows to pass the portion of the spectrum that contains the information of the signal of interest that it intended to be filtered. The intermediate frequency filtering device 90 may be, but not limited to, quartz filters, surface acoustic wave filters, or any other lumped elements filter device, distributed elements filter device, digital signal processing based filter device.

A second frequency translation device 100 takes the filtered signal of interest in the intermediate frequency. The second frequency translator device 100 is also fed by the frequency synthesizer 80 that generates the specific local oscillator. The second frequency translator device 100 transfers the signal of interest to the original frequency band. The second frequency translator device 100 may be, but not limited to, an analog circuit composed by an input radio frequency matching and filtering circuit that adapts impedances and/or eliminates unwanted CS radio frequency spectrum, an input radio frequency mixer that heterodinizes the intermediate frequency into original radio frequency spectrum.

A second filter selector 110 takes the original frequency band signal from the second frequency translator 100 and eliminates all false signals, harmonics, and images as a result of the frequency translation that were made. The second filter selector 110 can be, but not limited to, quartz filters, surface acoustic wave filters, or any other lumped elements filter device, distributed elements filter device, digital signal processing based filter device.

An amplifier 120 takes the filtered signal of interest from the second filter selector 110 and amplifies the signal. The amplifier 120 provides an amplified output level of the signal of interest to then send the amplified signal through an output connector 130 located on the filter system 10.

An internal control unit 140 controls the entire filter system 10. The internal control unit provides the filter system 10 with the operating parameters and controls the tuning of the synthesizer 60 that generates the specific local oscillator.

For its external communication, the filter system 10 may include communication ports and luminous and mechanical indicators 150 that are connected with the internal control unit 140.

The filter system 10 may be energized by an external energy source 160. The energy source 160, may be, for example, a power supply, a battery, a UPS system, an energy system of solar panel, or combination thereof.

The present invention also refers to a process that includes the steps of:

capturing the radio electric spectrum where the signal of interest of the telecommunications reception system is located. This capture may be carried out by using antennas or other radiant elements and/or capable of capturing radiated electromagnetic waves and/or conducted to the port entry of the filter by means of a radio frequency conductive element.

pre-filtering the received radio electric spectrum of interest with the objective of making an initial selection of the band of operation of the active filter;

amplifying the spectrum with low added noise (low noise figure) also providing variable gain stages so the user can manage the total gain level of the device;

reducing by heterodyne the radio electric spectrum, in which is located the reception signal of interest, to an intermediate frequency band;

filtering the signal of interest through filtering elements in the intermediate frequency whose bandwidth only lets to pass the bandwidth that contains useful information of the signal of interest and refuses any other spectral component that is out of the band; and

carrying the filtered frequency of interest from the interest intermediate band to the original radio electric spectrum band in order to be sent to the telecommunications receiver.

The programmable heterodyne active filter for telecommunications receivers according to the present invention presents the following advantages compared with the filter system of the known prior art:

low cost;

portable and includes a compact size similar in size to the telecommunications receivers.

presents a pass band type topology and with a very high quality factor which allows to provide very aggressive filtering to adjacent, semi-adjacent, and near channels.

includes gain stages of low level noise with the objective of preventing losses by inclusion.

is immune to adjacent, semi adjacent, or nearby signals, independent of their level, and these signals do not affect the operation of the solution, avoiding the degradation of the quality of the filtered signal of interest.

is immune to the existing floor level noise, where the floor level noise does not affect the operation of the solution, avoiding the degradation of the quality of the filtered signal of interest.

is suitable for any sort of technology independent of its modulation and which generates no quantization errors which prevent the integrity of the information carried by the filtered signal of interest.

can be adjusted in the field without the need for laboratory instrumentation, which can be adapted to changes in the frequency of the filtered signal of interest, without having to purchase a new unit and discard the existing.

is adjustable, enabling us to provide a multi-channel solution that operates simultaneously on all portions of the required spectrum, depending on the geographical context where the solution is applied.

It should be understood, of course, that the foregoing relates to exemplary embodiments of the invention and that modifications may be made without departing from the spirit and scope of the invention as set forth in the following claims.

What is claimed is:

1. A programmable heterodyne active filter system for a telecommunication receiver comprising:
a casing;
a printed circuit board housed inside the casing;
a capturing device operatively connected to the printed circuit board via an input connector on the casing, the capturing device captures and/or radiates electromagnetic wave signals present in a radio electric spectrum of interest of a telecommunication device;
the printed circuit board including:
a first pre-selection filter connected to the capturing device, the first pre-selection filter receives the captured signal from the capturing device and filters the capturing signal to an operational band;
an adjustable radio frequency amplifier connected to the first pre-selection filter, the adjustable radio frequency amplifier amplifies the filtered radio electric spectrum of interest, the radio frequency amplifier is of low level of added noise and includes an adjustable gain chain setting;
a first frequency translator device connected to the adjustable radio frequency amplifier, the first frequency translator device takes the amplified radio electric spectrum of interest exiting the radio frequency amplifier and creates a heterodyne reduction of the radio electric spectrum of interest to an intermediate frequency band;
an intermediate frequency filtering device connected to the first frequency translator device, the intermediate frequency filtering device filters the intermediate frequency signal according to a selectable bandwidth that only allows to pass a portion of the spectrum that contains the information of the signal of interest that it intended to be filtered;
a second frequency translation device connected to the intermediate frequency filtering device, the second frequency translation device transfers the filtered intermediate frequency signal to the original frequency band signal;
a second filter selector connected to the second frequency translation device, the second filter selector takes the original frequency band signal and eliminates false signals, harmonics, and images;
an amplifier connected to the second filter, the amplifier takes the filtered signal from the second filter selector and amplifies the signal and then sends the amplified signal through an output connector operatively connected to the printed circuit board;
an internal control unit independently connected to the pre-selection filter, the frequency synthesizer, and an external energy source.

2. A method for filtering a radio electric spectrum signal for a telecommunication receiver, the method comprising the steps of:
transporting to a location the programmable heterodyne active filter system for a telecommunication receiver of claim 1;
capturing the radio electric spectrum where the signal of interest of the telecommunications receiver is located;
pre-filtering the received radio electric spectrum of interest to make an initial selection of the band of operation;
amplifying the spectrum signal with low added noise and variable gain stages;
reducing by heterodyne the radio electric spectrum to an intermediate frequency band;
filtering the signal of interest through filtering elements in the intermediate frequency whose bandwidth only lets to pass the bandwidth that contains a selected information of the signal of interest and refuses spectral components that are out of the bandwidth; and
carrying the filtered frequency of interest from the interest intermediate band to the original radio electric spectrum band;
sending the signal to the telecommunications receiver.
